(19) United States
(12) Patent Application Publication
(10) Pub. No.: US 2003/0006829 A1
(43) Pub. Date: Jan. 9, 2003

(54) Power device with integrated voltage stabilizing circuit and method for manufacturing the device

(75) Inventors: Antonino Alessandria, Catania (IT); Leonardo Fragapane, Catania (IT)

Correspondence Address: MODIANO JOSIF, PISANTY, STAUB, EUROPEAN PATENT ATTORNEYS, U.S. PATENT AGENTS, Via Meravigli, 16, MILANO, I-20123, IT

(73) Assignee: STMicroelectronics S.R.L.

(21) Appl. No.: 10/189,019

(22) Filed: Jul. 5, 2002

(30) Foreign Application Priority Data
Jul. 9, 2001 (IT) MI2001A001461

(51) Int. Cl. G05F 1/10

(52) U.S. Cl. 327/538

(57) ABSTRACT

A power device with integrated voltage stabilizing circuit, comprising a MOS transistor that is connected in parallel to a circuit that is integrated in a power device, at least one Zener diode with a series-connected resistor being connected in parallel to the transistor, the gate terminal of the transistor being connected to an intermediate node between the Zener diode and the resistor, the anode terminal of the Zener diode and the drain terminal of the transistor being connected to an input voltage of the circuit.

### BACKGROUND OF THE INVENTION

The present invention relates to a power device with integrated voltage stabilizing circuit and to a method for manufacturing the device.

As is known, in a linear circuit the supply voltage is subject to variations that affect the operation and performance of the circuit. These variations can in fact affect the bias point of the transistors inserted in the circuit and accordingly all the electrical values involved in the control or regulation implemented by the circuit (voltages at the nodes, currents in the branches, loop gain).

The influence of these variations becomes even greater when the circuit is DC coupled, i.e., when there is no separation between the electrical bias values and the signal values.

However, in some applications, such as for example those in the automotive sector, it is not possible to use a voltage regulator that provides a stabilized voltage. Indeed, often the voltage is obtained by converting a current supplied by an upstream circuit with a termination of the open-collector type or by deriving it directly from the battery of the motor vehicle. Moreover, it is necessary to take into account the considerable variations that can occur on the ground connection.

The solutions and design techniques that tend to reduce the influence of the previously mentioned variations on the performance of the circuit are of course prior art, but there are cases in which intervention is not simple owing to factors that limit design freedom.

This is true, for example, when one wishes to provide circuits by means of integrated signal devices with an existing process that is already established for the manufacture of a power device in order to obtain a monolithic solution in which a single chip provides both the power section and a linear driver circuit.

In this case, there is no freedom of choice regarding the doses of the dopants and the thermal diffusion budgets to be used, since they are set by the manufacturing process of the power device.

FIG. 1 illustrates, as a block diagram, a monolithic device of the type described above. The control circuit implements a regulation on the driving of the main device, the power device 1, in order to protect it against overcurrents and excessive temperatures.

In this case, in FIG. 1 one can see a temperature sensing block 2, a current sensing block 3 and a voltage reference block 4. In this case, the supply voltage coincides with the driving voltage.

Variations on this voltage influence the operation of the majority of the blocks that are present in the circuit.

An example of such a device might be a monolithic IGBT of the full-protected type for electronic ignition. In this kind of device, the standard manufacturing process of the IGBT is utilized to produce some elementary components that allow integration of the corresponding control circuit.

As mentioned, the execution of the signal devices that allow this integration is not simple, since the structures and rules for layout have been devised as a function of the existing process, i.e., only and exclusively for the provision of the power section.

Moreover, the vertical structure and the bipolar conduction mechanism of an IGBT can produce malfunctions if one wishes to provide elementary components that utilize hole-based conduction mechanisms (bipolar PNP transistors or P-channel MOS transistors).

In fact, although the silicon region that contains the driver is conveniently isolated from the power section, the substrate still injects holes that interfere with the operation of the elementary component. Moreover, the bulk of this component would be physically connected to the collector (high-voltage terminal) of the IGBT.

Accordingly, the available technology allows to integrate MOS N-channel transistors, resistors and polysilicon diodes. However, despite the penalizations imposed by the reduced number of available elementary components, a device provided in this manner has the same manufacturing costs as a conventional device but offers a considerable added value.

Transistors obtained in this manner, however, have a breakdown voltage close to 5 V and therefore their use is tied to applications in which the supply voltage is not higher than 5 V.

Moreover, in a transistor of this kind the channel length modulation effect begins already at low voltages (approximately at 2.5 V), introducing great uncertainties on the bias point and accordingly on the electrical output values of the circuit.

Another important aspect relates to the stabilization of the power supply voltage and to the provision of voltage references in a circuit integrated in a power device.

One method that is widely used to provide the above, in order to contain voltage fluctuations, consists in inserting a Zener diode in parallel to the voltage to be stabilized, as shown in FIG. 2, in which the reference numeral 4 designates the circuit whose voltage is to be stabilized and the reference numeral 5 designates the Zener diode.

However, one must take into account the fact that diodes have an intrinsic incremental resistance that depends on the process parameters (on the order of one hundred ohms in the case of silicon junction diodes) and does not allow to achieve fully satisfactory results.

This situation becomes even more severe in the case of polysilicon diodes, for which the incremental resistance values are very high (on the order of a few kΩ).

Moreover, one must not neglect the fact that silicon diodes can introduce parasitic components that compromise the operation of the main device, while the use of polysilicon diodes has the advantage of eliminating parasitic components. The diodes are in fact provided in polysilicon islands that are separate from the main structure and are isolated vertically by means of a thick oxide layer. Moreover, it is observed that in the case of integration with a power device, the problem is more complex, because the design choices made in order to improve the performance of the signal devices are limited by the manufacturing process of the main device: the doses of the doping species and the thermal process in fact cannot be changed with absolute freedom.

Another aspect to be considered is the short circuit robustness of an IGBT, for which there is a correlation between the short-circuit time (t_{wsc}) and the current carrying capacity, as shown in FIG. 3.

Currently, short circuit robust fast IGBTs are produced by altering the standard manufacturing process so as to reduce the current carrying capacity (variation of the thickness of the gate oxide and of the BODY implantation dose) and insert ballast resistors on the emitter of the IGBT (changes to the layout of the SOURCE and CONTACT photoengravings).

It is easily understandable that such a device is extremely complicated to manufacture and that there are many process variables involved in this case, contributing to an increase in the spread of the electrical parameters of the device and accordingly on the figure of merit of the short-circuit time.

The electrical parameters directly affected by the process variations introduced in order to provide the short circuit robust device are listed here:

variability of the threshold voltage introduced by the tolerance on grown gate oxide thickness and by the uncertainty introduced by the BODY implantation and diffusion;

variability of the ballast resistors, introduced by the tolerance on the misalignment with respect to the SOURCE and CONTACT photoengravings;

variability of the gain of the PNP that is intrinsic to the structure of the IGBT introduced by the uncertainty on the life time in the initial epitaxial layer and on its final value, suitably modified by the implantation and diffusion of a life-time killer (for example platinum).

Finally, it should be specified that this protection method can be used only for an IGBT of the fast type. To understand the reason for this statement, the relation that links the design and process parameters to the saturation current I_{SAT} is examined; this relation is of the following kind:

I_{SAT}−I_{MOS}(1+β_{PNP})

where β_{PNP} is the gain of the bipolar transistor that is intrinsic to the structure of the IGBT.

In our case, in an IGBT of the fast type the gain is very low (β_{PNP}−0.2), while in a low-drop IGBT the gain is very high (βPNP−0.6). If the other process and layout parameters (affecting the MOS current section) are the same, the variation in the gain β_{PNP} (linked in particular to the life-time killing method) implies an increase of approximately 30% in the saturation current. However, in both categories of device it is not possible to perform methods for varying the gain, since the particular electrical characteristics (t_{fall}, tᵣᵢₛₑ, E_{off} and V_{CEsat}) that determine its application would be altered consequently. Accordingly, the current method used to manufacture short-circuit robust IGBTs is not applicable to IGBTs of the low-drop type but only to fast IGBTs.

### SUMMARY OF THE INVENTION

The aim of the present invention is to provide a power device with integrated voltage stabilizing circuit.

Within this aim, an object of the present invention is to provide a power device with integrated voltage stabilizing circuit with an increase in the breakdown voltage of the MOS transistor to values equal to, or higher than, 10 V, allowing to use power supply voltages of up to approximately 15 V.

Another object of the invention is to provide a power device with integrated voltage stabilizing circuit that can be manufactured with layout and process modifications without altering the number of process steps required to produce it.

Another object of the invention is to provide a power device with an integrated voltage stabilizing circuit that is highly reliable, relatively simple to manufacture and at competitive costs.

This aim and these and other objects that will become better apparent hereinafter are achieved by a MOS signal transistor with high breakdown voltage, integrated in a power device, comprising drain, gate and source terminals which have a first type of doping, and a bulk region that delimits said terminals, characterized in that the structure of said drain terminal is physically separate from said bulk region, a region doped with a different doping with respect to said first type of doping being formed in order to provide electrical continuity between said drain terminal and said bulk region.

### BRIEF DESCRIPTION OF THE DRAWINGS

Further characteristics and advantages will become better apparent from the following detailed description of preferred but not exclusive embodiments of the device according to the invention, illustrated by way of non-limitative example in the accompanying drawings, wherein:

FIG. 1 is a block diagram of a power device with a linear driving circuit of a known type;

FIG. 2 is a block diagram of a method for stabilizing the power supply voltage of a circuit;

FIG. 3 is a chart which plots the correlation between the short-circuit time and the current carrying capacity of an IGBT;

FIG. 4a is a view of a known type of layout of a MOS signal transistor integrated in a power device;

FIG. 4b is a view of the modified layout of the MOS signal transistor integrated in a power device according to the invention;

FIG. 5 is a view of a circuit suitable to stabilize the power supply voltage in a circuit integrated in a power device;

FIG. 6 is a chart that compares two current/voltage characteristics, one in the case in which the Zener diode alone is used, the other one in the case in which the circuit shown in FIG. 5 is used;

FIG. 7 is a circuit diagram of a variation of the circuit of FIG. 5;

FIG. 8 is a view of a circuit for providing voltage references in a circuit integrated in a power device;

FIG. 9 is a view of a variation of the circuit of FIG. 8;

FIG. 10 is a view of another variation of the circuits of FIGS. 8 and 9;

FIG. 11 is a view of an IGBT power device with a circuit integrated in order to improve the short-circuit robustness of said device;

FIG. 12 is a chart that compares two output characteristics that can be obtained with an input voltage of 15 V for a standard device and for a device with the integrated circuit shown in FIG. 11; and

FIG. 13 is a chart that plots the same output characteristics with a scale that allows to observe clearly the behavior proximate to zero.

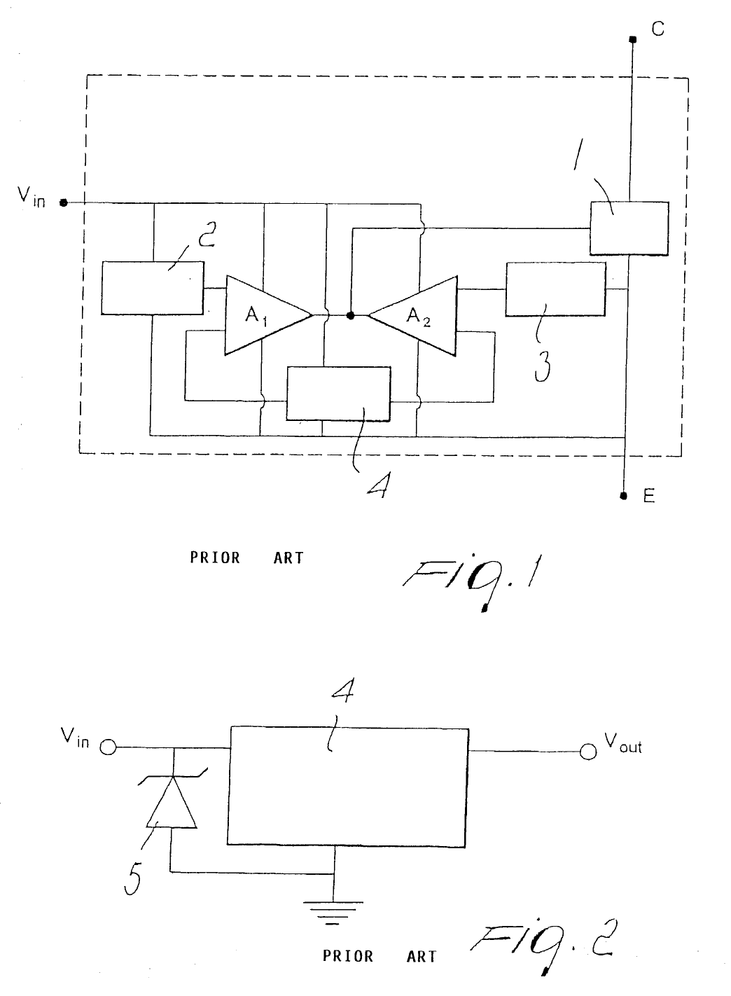

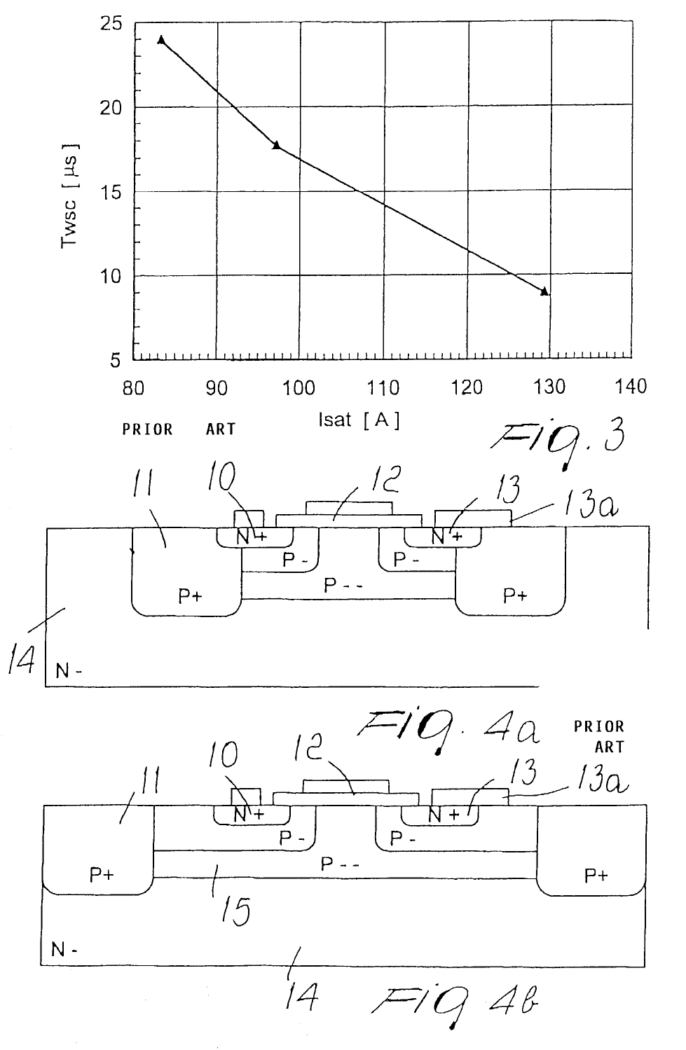

### DESCRIPTION OF THE PREFERRED EMBODIMENTS

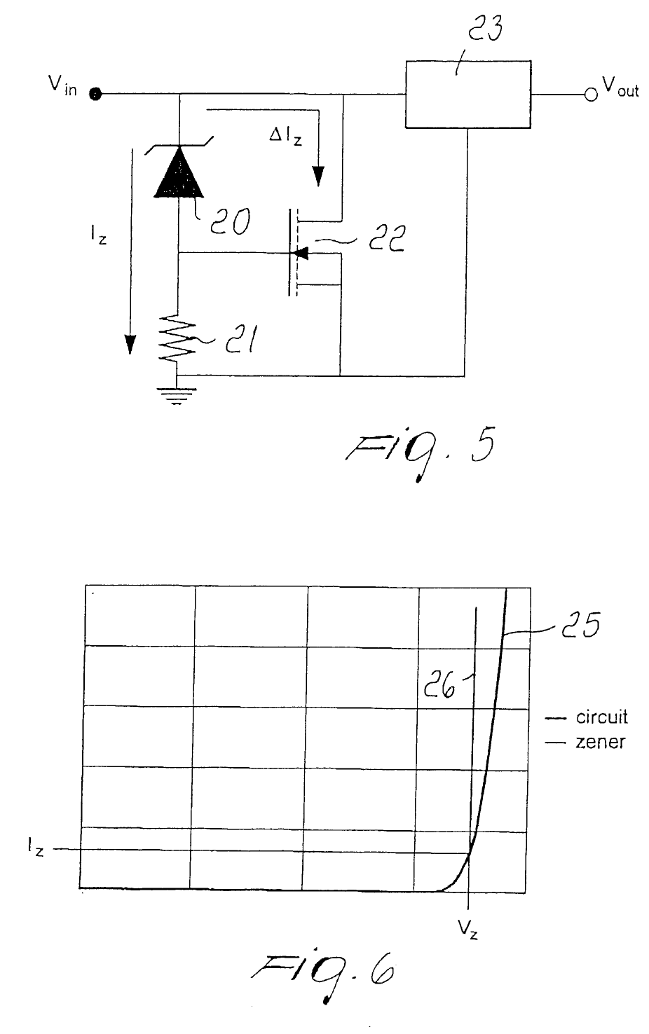

With reference to the figures, and particularly to FIGS. 4a and 4b, FIG. 4a illustrates a structure of a MOS transistor of a known type, in which the breakdown is determined by the breakdown of the drain-bulk junction. As shown in FIG. 4a, part of the drain structure, designated by the reference numeral 10, partially overlaps the bulk region 11, which is doped with boron, whose doping is designated by P+.

The junction thus formed has a breakdown close to approximately 5 V.

In FIG. 4a, the reference numeral 12 designates the gate region, the reference numeral 13 designates the source region, the reference numeral 13a designates the source/bulk contact with the corresponding short circuit and the reference numeral 14 designates the substrate on which the MOS transistor is provided.

Therefore, in order the overcome the limit of the breakdown voltage of 5 V, according to the present invention, as shown in FIG. 4b, it is necessary to set, during the manufacture of the MOS transistor, a distance between the mask used to form the source region 13 and the drain region 10 and the mask used to form the bulk region 11 that avoids the overlap of the drain region 10 and the source region 13 with the bulk region 11.

This is shown in detail in FIG. 4b, in which it is evident that the drain region 10 and the source region 13 are separated from the bulk region 11, i.e., there is no more overlap as instead occurs in the device shown in FIG. 4a.

The junction obtained by means of the device shown in FIG. 4b, without altering the concentrations of the dopants used to provide the main power device, has a breakdown voltage close to 10 V. However, in order to ensure electrical continuity with the bulk region 11, which is P+ doped, to avoid problems of abnormal failure of the device (premature latching) or a reduction in the breakdown voltage of the main device, a boron well designated by the reference numeral 15 (P—doping) is provided which accordingly allows electrical continuity between the region designated by P− and the region 11, but does not alter the breakdown voltage of the device.

The concentration of boron under the drain region 10 is determined mainly by the dose of the BODY of the device, i.e., the P− region. This concentration varies in the range between 1.10¹⁷ and 3.10¹⁷ ions/cm³.

The concentration of the region 15 is instead variable between 1.10¹⁶ and 5.10¹⁶ ions/cm³; accordingly, this concentration does not affect the breakdown voltage of the MOS transistor.

The solution shown in FIG. 4b is valid regardless of the dimensions of the polysilicon that constitutes the gate of the device, even if the two wells designated by P− join by lateral diffusion.

Moreover, the functionality of the transistor continues to be valid if both wells, or one of them, designated by P−, are eliminated. In this case, the channel region of the device is uniformly doped with the layer designated by P—(reference 15). As regards the electrical characteristics of the transistor thus provided, one obtains a higher breakdown voltage—higher than 18 V—and at the same time a lower threshold voltage. This electrical characteristic can be realigned to the chosen values, without altering the value of the breakdown voltage, by acting on the thickness of the gate oxide.

A first application of the MOS signal transistor provided by means of the configuration of the processes described above is possible in the stabilization of the supply voltage in a circuit integrated in a power device.

By way of the invention it is possible to find a solution to the stabilization of the supply voltage by means of an elementary circuit solution that uses a Zener diode (reference should be made to FIG. 5) 20, a resistor 21 and a MOS signal transistor 22, of the type produced by means of the configuration and process modifications described earlier and illustrated with reference to FIG. 4b.

The reference numeral 23 designates the control circuit integrated in a power device.

FIG. 6 illustrates the comparison between two current-voltage characteristics: one represents the case in which only the Zener diode, designated by the reference numeral 25, is used; the other one represents the case in which the circuit shown in FIG. 5 (curve designated by the reference numeral 26) is used.

It should be observed that the incremental resistance observed when using the Zener diode depends on the process parameters, whereas in the second case, since it is set by an appropriate choice of the circuit values, its values can become substantially zero. The characteristic of the diode 20, the value of the resistance 21 and the threshold voltage of the MOS transistor 22 are the design parameters that allow to fix the latch-up point of the circuit.

For example, assuming that one wishes to set a voltage Vin at the input of the circuit, a current I_{Z} is detected at which the diode 20 has, across it, a voltage V_{Z}=Vin−V_{TH}, where V_{TH} is the threshold voltage of the MOS signal transistor 22 that is being used. At this point it is necessary to choose a resistance 21, provided by the ratio between the threshold voltage and the current that passes through the Zener diode I_{Z}. In this manner, the current in the branch in which the diode 20 and the resistor 21 are present remains fixed at I_{Z} and the excess current I_{Z} is absorbed by the MOS transistor 22.

Likewise, the voltage at the input of the circuit is set to Vin=V_{Z}+RI_{Z}, where R is the resistor 21, and its upward fluctuations are clipped and not transferred downstream. In other words, starting from the chosen voltage, the incremental resistance of the entire circuit block is reduced.

It should be observed that it is possible to make appropriate design choices so that the compensation is stable throughout the operating temperature range of the circuit. One should in fact bear in mind that:

the breakdown voltage of a Zener diode increases as the temperature increases;

the threshold voltage of a N-channel MOS transistor decreases with the temperature;

the resistance has a different behavior according to the temperature depending on the type of dopant used (for example in the case of the production of polysilicon resistors doped with boron or arsenic) and on the implanted dose.

An interesting modification to the circuit can be performed by adding an additional Zener diode connected so that its anode terminal is in common with the anode terminal of the Zener diode 20. This second diode is designated by the reference numeral 30.

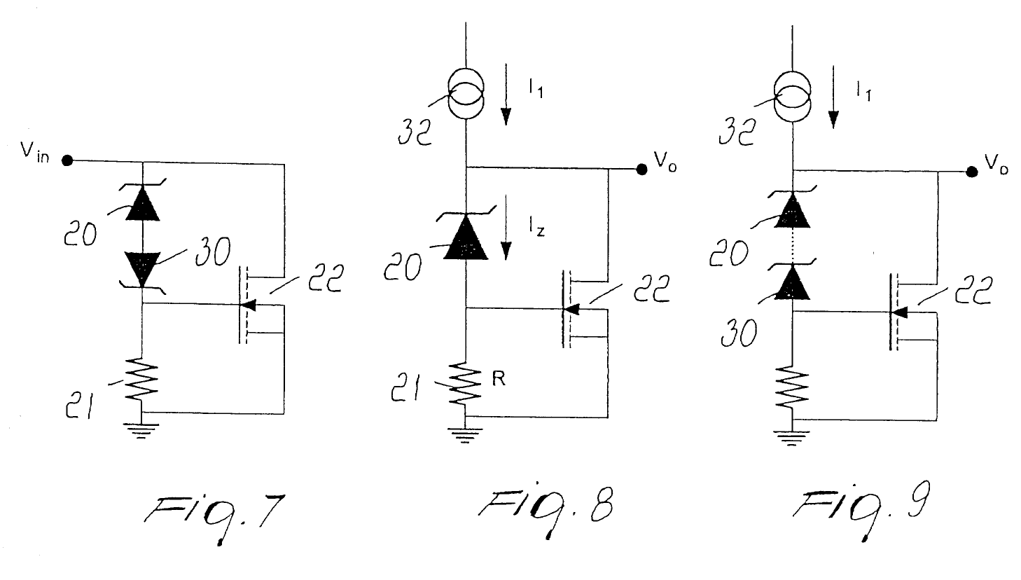

The corresponding circuit diagram is shown in FIG. 7.

The above described relations are therefore modified appropriately and the input voltage is stabilized at the value Vin=V_{f}+V_{Z}+RI_{Z}.

In this manner, one can obtain advantages both in terms of design and in terms of application:

from the design standpoint, it is possible to further modify the temperature behavior of the circuit, obtaining a compensation effect between the direct and inverse voltage of the diodes. These two values in fact have opposite temperature-dependent behaviors;

from the application standpoint, the added diode 30 could protect the circuit against overvoltages below the ground level. This property is useful both during the assembly of the device (for example in case of accidental terminal reversal) and during operation (voltages that during the application, by going below the ground level, might destroy components integrated in the circuit).

The appropriate sizing of these parameters allows to stabilize the supply voltage in all operating conditions.

Another application of the invention is the provision of voltage references in a circuit integrated in a power device.

A circuit configuration similar to the one described in the preceding paragraph can be used to obtain (see FIG. 8), inside a monolithic power device with an integrated control circuit, a voltage reference that is stable as the temperature and power supply vary. Assuming that one has available a current source 32 and one wishes to obtain a voltage reference, it is possible to use the configuration shown in FIG. 8, in which reference numerals that are identical to the preceding figures designate identical elements.

The output voltage V₀ is stabilized at the value V₀=V_{Z}+V_{TH}, while the oscillations of the current 11 of the current source around its nominal value are absorbed by the MOS transistor 22. It is of course necessary to ensure that the conditions I₁>I_{Z} are met and that the voltage across the resistor 21 is approximately equal to the threshold voltage of the transistor 22.

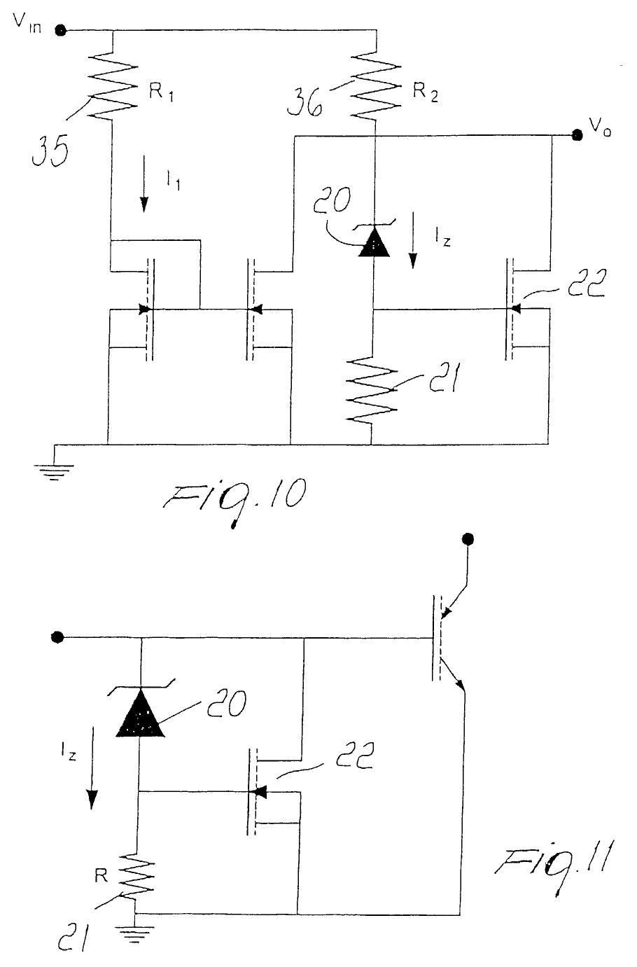

The output voltage can be changed in whole multiples of V_{Z} by inserting other Zener diodes as shown in FIG. 9. In this case, one has V₀=nV_{Z}+V_{TH}, where n is equal to the number of inserted Zener diodes.

A finer adjustment can be provided by also inserting forward-biased diodes. In this case, the reference voltage is given by the expression V₀=nV_{Z}+mV_{f}+V_{TH}. As can be understood from this expression, the reference can be changed at will by the designer over a rather wide range. One should also consider the temperature stabilization mechanism that comes into action when diodes are connected in a so-called back-to-back configuration, in view of the different temperature-dependence of V_{Z} and V_{f}.

The two solutions can be obtained easily by also integrating a circuit that acts as a current mirror, i.e., by providing a current source, as shown in FIG. 10. The transistors that form the current mirror have the same V_{GS} and therefore the same current. This current is set by the value of the resistor 35 according to the approximate relation I₁=(Vᵢₙ−V_{TH})/R₁, where R₁ is the resistor 35. The resistor 36, designated in the following formula by the reference sign R₂, must instead be chosen according to the relation R₂=(Vᵢₙ−V_{Z}−V_{TH})/(I₁+I_{Z}).

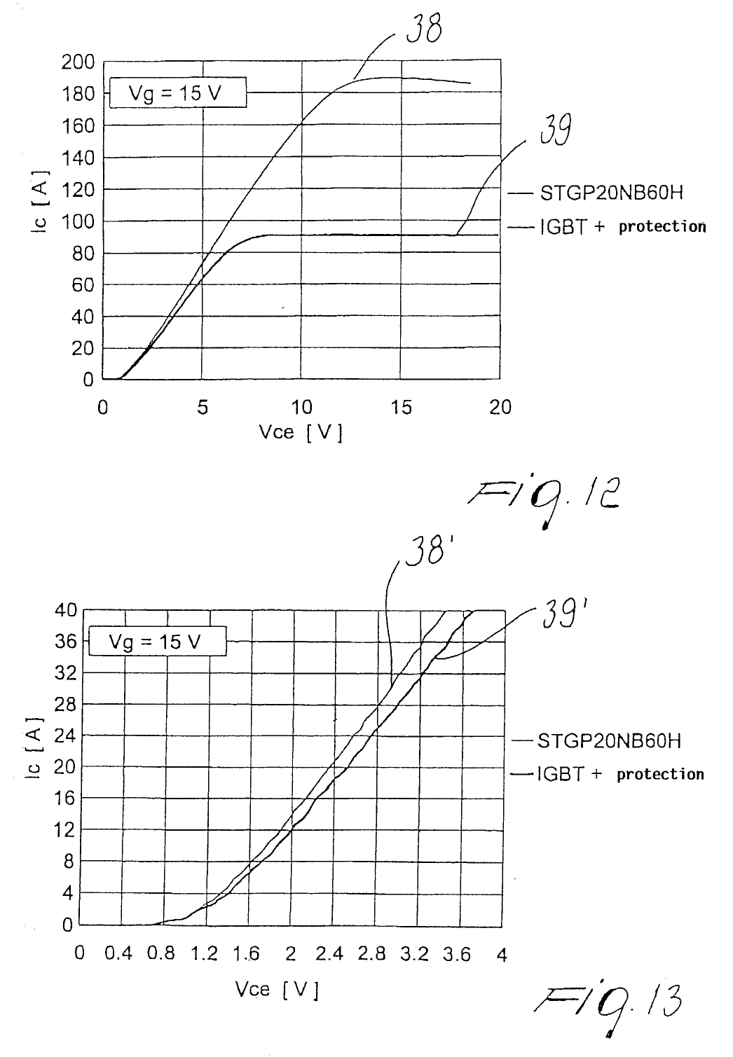

In a third application of the MOS transistor executed according to the invention, it is possible to provide an integrated circuit suitable to lock the driving voltage of a device upstream of the gate terminal by means of one of the previously described circuit configurations, as shown in FIG. 11.

FIG. 12 illustrates the comparison between the two output characteristics obtained with the input voltage of 15 volts for a standard device and for a device with the integrated circuit. It should be noted that the locking of the input voltage considerably reduces the current carrying capacity of the device.

The reference numeral 38 in fact designates the characteristic curve that can be obtained with a standard device, and the reference numeral 39 designates the same characteristic curve obtained with a device provided with the integrated circuit.

FIG. 13 illustrates the same two output characteristics as FIG. 12, with a scale that allows to compare performance as regards the saturation voltage between the collector and the emitter at the nominal current of the device used for the test (20 A). The degradation of the parameter of interest is substantially negligible. The reference numeral 38′ designates the curve that corresponds to the curve 38 of FIG. 12, and the same applies likewise for the reference numeral 39′.

In practice, it has been observed that the MOS transistor manufactured according to the method described in the present invention achieves the above aim and objects and is therefore usable in power devices with integrated voltage stabilization circuit.

The device and the method thus conceived are susceptible of numerous modifications and variations, all of which are within the scope of the appended claims.

All the details may further be replaced with other technically equivalent elements.

The disclosures in Italian Patent Application No. MI2001A001461 from which this application claims priority are incorporated herein by reference.

What is claimed is:

1. A MOS signal transistor with high breakdown voltage, integrated in a power device, comprising drain, gate and source terminals which have a first type of doping, and a bulk region that delimits said terminals, wherein the structure of said drain terminal is physically separate from said bulk region, a region doped with a different doping with respect to said first type of doping being formed in order to provide a region of electrical continuity between said drain terminal and said bulk region.

2. The transistor according to claim 1, wherein said region suitable to provide electrical continuity further connects said source terminal to said bulk region.

3. The transistor according to claim 2, wherein said bulk region is doped with boron.

4. The transistor according to claim 1, wherein said first type of doping is doping provided by means of boron.

5. The transistor according to claim 3, wherein the boron concentration at said drain terminal is between 1*10¹⁷ and 3*10¹⁷ ions/cm³.

6. The transistor according to claim 5, wherein said region of electrical continuity is doped with boron at a concentration between 1* 10¹⁶ and 5*10¹⁶ ions/cm³.

7. The transistor according to claim 1, wherein the breakdown voltage of said transistor is at least equal to 10 V.

8. The transistor according to claim 5, wherein the boron concentration of said bulk region is higher than the boron concentration of said region of electrical continuity, which in turn is lower than the boron concentration at said drain terminal.

9. A power device with integrated voltage stabilizing circuit, comprising a MOS transistor according to claim 1, which is connected in parallel to a circuit that is integrated in a power device, at least one Zener diode with a series-connected resistor being connected in parallel to said transistor, the gate terminal of said transistor being connected to a node that is intermediate between said Zener diode and said resistor, the anode terminal of said Zener diode and the drain terminal of said transistor being connected to an input voltage of said circuit.

10. The device according to claim 9, comprising an additional Zener diode connected in back-to-back configuration to said at least one Zener diode.

11. A circuit for providing a voltage reference in a circuit integrated in a power device, comprising a transistor according to claim 1, which is connected in parallel to a circuit branch that comprises at least one Zener diode with a series-connected resistor, the gate terminal of said transistor being connected to a node that is intermediate between said Zener diode and said resistor, the anode terminal of said Zener diode and the drain terminal of said transistor being connected to a current source.

12. The circuit according to claim 11, comprising at least one additional Zener diode that is connected in series to said at least one Zener diode.

13. The circuit according to claim 11, comprising at least one additional Zener diode that is series-connected in a back-to-back connection to said at least one Zener diode.

14. An IGBT with high short-circuit resistance, comprising, between the gate terminal and the source terminal, a device according to claim 9.
